(19) United States
(12) Patent Application Publication
(10) Pub. No.: US 2015/0374150 A1
(43) Pub. Date: Dec. 31, 2015

(54) TABLE SKIRT

(71) Applicant: Freeman Capital Company, Las Vegas, NV (US)

(72) Inventor: Marilyn Garrett, Dallas, TX (US)

(21) Appl. No.: 14/316,595

(22) Filed: Jun. 26, 2014

(51) Int. Cl. A47G 11/00; B32B 38/00; A47F 13/00

(52) U.S. Cl. CPC A47G 11/006; A47F 13/00; B32B 38/0004; B32B 2307/306; B32B 2323/043

(57) ABSTRACT

A table skirt and its production method for efficient deployment and recycling in show business or other public events are presented. The table skirt is washable, fire resistant and wrinkle resistant and enables easy and efficient installation and removal. Specifically, the table skirt uses one or more attachment strips sewn to a fabric material for maintaining an aesthetically pleasant shape (e.g., a pleated rectangle). The attachment strips include a carrier, a film of adhesives, and a protective layer.

### FIELD

This disclosure relates to table skirt for covering show tables.

### BACKGROUND

In exhibitions, conferences, events, tradeshows, and other show-related businesses, exhibitors and vendors often use table skirts to cover and dress show tables to improve overall aesthetics and make use of the spaces covered by the table top and the table skirts. Due to the nature of tradeshow businesses, such table skirts can experience repetitive setup and removal and maintenance, which can be inefficient. Table skirts can be slow to deploy in a large event or tradeshow (e.g., in an event or tradeshow having hundreds of tables).

### SUMMARY

This disclosure presents a table skirt for efficient deployment and collection by use of an attachment strip enabling quick attachment and removal. The table skirt includes a fabric material having a top side and the bottom side. The bottom side is opposite and parallel to the top side. An attachment strip pleats the fabric material by overlapping part of the top side onto itself to create a curve shape of the bottom side. The attachment strip includes a protective layer, a film of adhesives, and a carrier. The carrier is secured to the pleated top side of the fabric material by a thread or a layer of adhesives.

In one specific aspect, the fabric material further includes a mesh of durable fibers that are resistant to a cleansing detergent.

In another specific aspect, the fabric material is fire resistant and abides by at least one of CA 117, BS 5815-1 2005, BS 5852:2006, BS 7175, CRIB 5, IMO A563, and NFPA 701 standards. In some instances, the fabric material includes polyester.

In yet another specific aspect, the fabric material is cross-linked. For example, the fabric material includes cellulose molecules having strengthened hydrogen bonds.

In one specific aspect, the protective layer includes silicone or polytetrafluoroethylene.

In another specific aspect, the film of adhesives and the layer of adhesives may include one of water-based synthetic lattices, Kathleen/vinyl acetate, the click pressure-sensitive tape, solvent-based single-component polyurethane, synthetic rubber, and hot glue.

In yet another specific aspect, the carrier includes high-density polyethylene fibers.

In one specific aspect, the thread has a weight of about 4 to 8 ounce. In some embodiments, the thread further includes polyester or para-aramid synthetic fibers.

In another specific aspect, the thread is stitched at the width of the protective layer to hold the attachment strip onto the fabric material.

In a second general aspect, a method for manufacturing the above-mentioned table skirt can include cutting a fabric material having a top side and bottom side opposite and parallel to the top side. An attachment strip is aligned adjacent the top side. The attachment strip includes a carrier. The top side of the fabric material is then pleated. The pleated top side is further secured with the carrier.

In one specific aspect, securing the pleated top side with the carrier further includes stitching a thread through the fabric material and the carrier or applying a layer of adhesives between the carrier and the pleated top side.

In another specific aspect, the method includes treating the fabric material with a mineral-based barrier.

In yet another specific aspect the method includes treating the fabric material with mono-basic acid chlorides.

In one specific aspect, the method further includes applying a film of adhesives onto the carrier. A protective layer is further applied onto the film of adhesives. In some embodiments, the carrier, the film of adhesives, and the protective layer may be pre-assembled as a complete attachment strip prior to be secured onto the fabric material.

In another specific aspect, the carrier includes high-density polyethylene fibers.

Other aspects, features, and advantages will become apparent from the following detailed description when taken in conjunction with the accompanying drawings, which are part of this disclosure and which illustrate, by way of example, principles of the disclosure.

### BRIEF DESCRIPTION OF FIGURES

FIG. 1 is a perspective view of a table skirt installed on a show table.

FIG. 2 is a front view of the fabric material used to make the table skirt shown in FIG. 1.

FIG. 3 is a detail view of the attachment strip of the table skirt shown in FIG. 1.

FIG. 4 is a flow chart of a method for manufacturing the table skirt shown in FIG.

Like elements are labeled with like reference numerals.

### DETAILED DESCRIPTION

This disclosure presents a table skirt and its production method for efficient deployment and recycling in conventions, conferences, or other public events. The table skirt is washable, fire resistant and wrinkle resistant and enables easy and fast installation and removal. Specifically, the table skirt uses an attachment strip sewn to a fabric material for maintaining an aesthetically pleasant shape having a skirt pattern. The attachment strip enables quick attachment to a show table and easy peel-off removal. In some instances, the table skirt is disposable. In other instances, the table skirt is reusable.

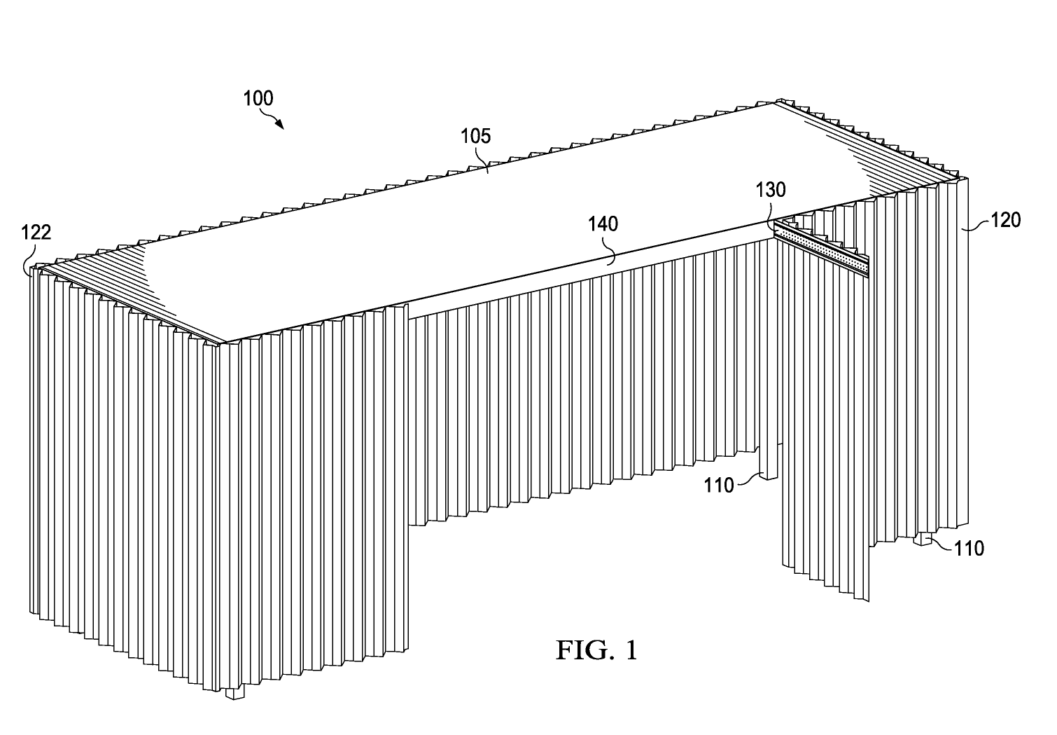

FIG. 1 is a perspective view of a table skirt 100 installed on a show table 105. The show table 105 has legs 110 near the corners or edges of the table 105. Although the table 105 is illustrated as a rectangular table, the table 105 may have any shape, such as a multilateral shape, circular/elliptical shape, or a combination thereof, such as a pentagon table, a round table, among others. When the table 105 is of a shape different from the illustration shown in FIG. 1, the legs 110 can be positioned at different locations on the table.

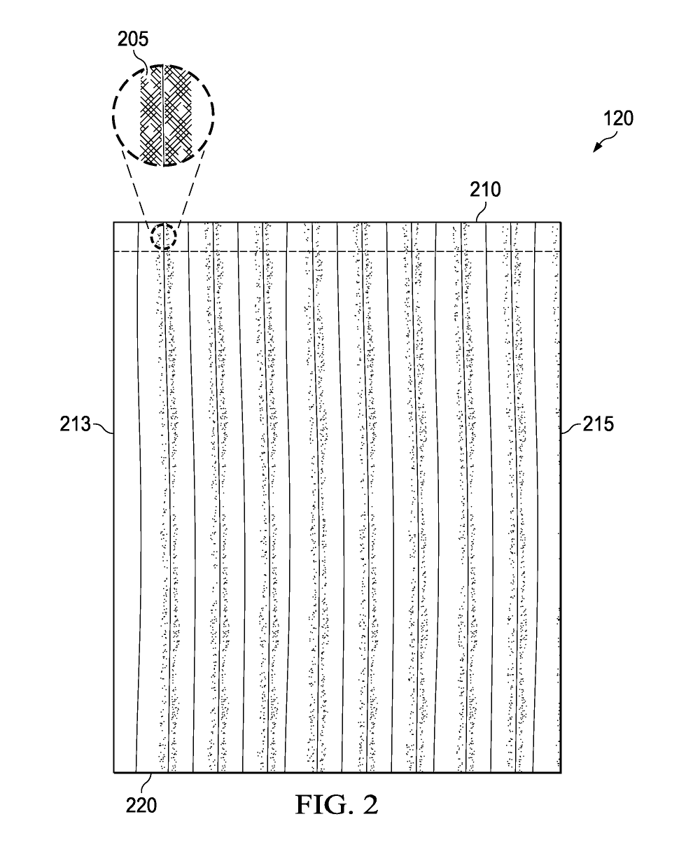

When installed, the table skirt 120 hangs from the table top, apron, or side edges and covers the space under the table 105. The skirt 120 can be secured onto a horizontal side surface 140 at the side edge of the top of the table 105. The table skirt 120 includes a horizontal attachment strip 130 for adherence to the surface 140. The table skirt 120 may be adhered to the surface 140 starting anywhere of the perimeter of the top of the table 105, such as a center location as illustrated in FIG. 1. The table skirt 120 includes folded patterns or skirt pleating 122 for aesthetics. The skirt pleating 122 may be achieved by folding portion of the table skirt 120 onto itself. The horizontal attachment strip 130 is stitched to the skirt 120 such that the skirt pleating 122 does not negatively affect its adherence (e.g., by reducing contact surface area of the attachment strip 130) to the horizontal side surface 140. Details of the structure of the table skirt 120 are described below in FIG. 2.

FIG. 2 is a front view of the fabric material 205 used to make the table skirt 120. The fabric material 205 has a top side 210 and a bottom side 220. The bottom side 220 is opposite and parallel to the top side 210. In a preferred embodiment, the top side 210 and the bottom side 220 are of the same length. In other embodiments, the top side 210 and the bottom side 220 are of different lengths. The two lateral sides 213 and 215 may be of the same length such that when the fabric material 205 is made into the table skirt 120, the table skirt 120 appears rectangular. In some embodiments, the length of the final rectangular shape may be between 4.1 and 4.3 meters (about 13′-6″ and 14′). The length of the laterals 213 and 215 may be between 700 mm and 990 mm (about 28″ and 40″).

In some embodiments, the length of the folded top side 210 and the bottom side 220 is a predetermined standard value. In some other embodiments, the length can be tailored to a particular show table 105. The length may equal to a full circumference of the show table 105. In other examples, the length equals to half of the full circumference. In some other examples, the length equals to a side of the show table 105. In some other examples, the length is greater than the full circumference such that the table skirt 120 can wrap around the full circumference and overlap a portion to itself.

The fabric material 205 is made of a mesh of durable fibers that are resistant to a cleansing detergent, such as sodium carbonate, sodium triphosphate, zeolites, chlorophyll, tannins, humic acids, linear alkylbenzenezulfonates, and stain-removing enzymes. For example, the durable fibers can be wool, flax, cotton, nylon, or other materials forming long strands. In general, the fabric material 205 is a textile of a network of the durable fibers formed by weaving, knitting, crocheting, knotting, or pressing the durable fibers together. The fabric material 205 may generally be any fabric, cloth, or textile containing the durable fibers, including animal textiles (e.g., hair, fur, skin, silk), plant textiles (e.g., grass, rush, hemp, sisal), mineral textiles (e.g., basalt fiber, glass fiber, metal fiber), and synthetic textiles (e.g., polyester, aramid, acrylic, nylon, spandex, polylactide, etc.).

The fabric material 205 is generally fire resistant and abides by at least one of BS 5815-1 2005, BS 5852:2006, BS 7175, CRIB 5, IMO A563, and NFPA 701 standards. For example, the fabric material 205 can include polyester and is inherently flame retardant. In some implementations, the fabric material 205 is treated with flame-retarding chemicals (e.g., a mineral based barrier) to increase flame resistance. In addition, the fabric material 205 may be treated by crosslinking to achieve a wrinkle-free effect. For example, the fabric material 205 includes a polymer (e.g., polyester, nylon, etc.) that can be joined together chemically (i.e., crosslinking by treating with mono-based acid chlorides). The crosslinking process strengthens hydrogen bonds in the cellulose molecules of the polymer. Therefore the fabric material 205 having the crosslinked polymer can be resistant to wrinkling. The washable, fire-resistant, and wrinkle-resistant fabric material 205 is further finished into the table skirt 120 shown in FIG. 2B.

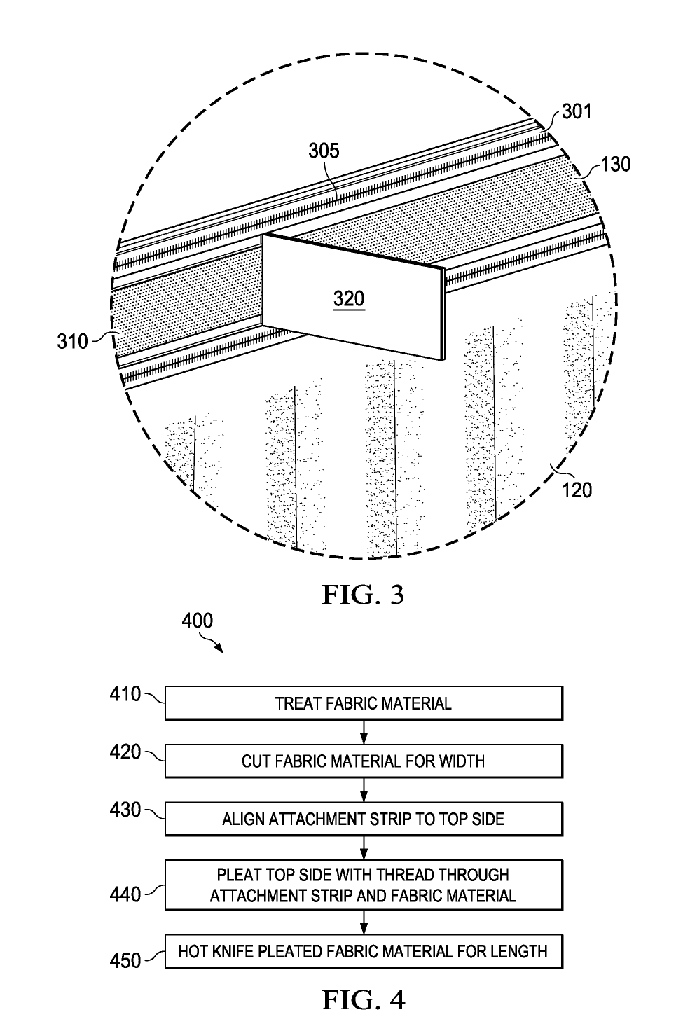

The table skirt 120 further includes the attachment strips 130. A detailed view of the attachment strip 130 is illustrated in FIG. 3, which shows portion of the back of the table skirt 120. Referring to FIG. 3, a thread 305 holds the fabric material 205 into a rectangular shape by overlapping part of the top side 210 onto itself to create a curve shape of the bottom side 220. For example, the thread 305 holds the fabric material 205 to form the pattern 120. The thread 305 may use double needle pleating with two threads or more. The attachment strip 130 includes a carrier 301, a film of adhesives 310, and a protective layer 320. The carrier 301 is stitched with the thread 305 adjacent and parallel to the top side 210 of the fabric material 205. This configuration allows the carrier 301 and the thread 305 to both hold the fabric material 205 into the finished rectangular shape and provide fixation forces needed to hold the table skirt 120 at the horizontal side surface 140 of the show table 105.

The carrier 301 is a layer of tear resistant material that can form a strong bond with the film of adhesives 310. In some embodiments, the carrier 301 includes high-density polyethylene fibers. The film of adhesives 310 can include water-based synthetic lattices, ethylene/vinyl acetate, acrylic pressure-sensitive tape, solvent-based single-component polyurethane, synthetic rubber, hot glue, among others. In some implementations, the film of adhesives 310 may include touch fasteners that have small hooks for engaging other fabric surfaces. The protective layer 320 is a layer of release medium to protect the film of adhesives 310 from adhering to other substances. In some implementations, the protective layer 320 includes silicone or polytetrafluoroethylene.

The thread 305 has a weight of about 4 to 8 ounces. In some embodiments, the thread 305 can have a weight between 5 to 7 ounces. In some other embodiments, the thread 305 can have a weight of about 6 ounces. The thread 305 can be made of polyester or para-aramid synthetic fibers. For example, the thread 305 is made of polyester or para-aramid fibers for its strength, high elastic modulus, high tenacity, low creep, low elongation at break, and other strength related properties. The thread 305 provides a lightweight, reliable, and secure connection between the carrier 301 and the fabric material 205. The film of adhesives 310 holds the carrier 301 to the horizontal side surface 140 and overcomes the weight of the table skirt 120. Excessive removal forces (e.g., tear forces provided by a human) can efficiently remove the table skirt 120 by breaking the adhesion between the side surface 140 and the attachment strip 130 without leaving adhesives residual.

Although FIG. 3 illustrates the use of a thread 305 to hold the attachment strip 130 to the table skirt 120, in some other embodiments, a film of adhesives or glue in general may be used in the place of the thread 305. For example, a film of adhesives may be applied between the carrier 301 of the attachment strip 130 and the pleated top side 210. The film of adhesives may be curable by heat or chemical means to permanently hold the pleats created at the top side 210. The film of adhesives has sufficient physical properties to resist tearing forces created during handling, installation, removal, or holding the table skirt against its own gravity. Some advantage of using the film of adhesives in the place of the thread 305 is includes evenly distributing loads to the carrier 301 and higher production efficiency than the use of the thread 305.

In some embodiments, the thread 305 is stitched into the attachment strip 130 at the width of the protective layer 320, such that both the protective layer 320 and the carrier 301 are secured to the fabric material 205. During deployment, the protective layer 320 may be torn away from the thread 305 without breaking the thread 305 and expose the film of adhesives 310.

FIG. 4 is a flow chart 400 of a method for manufacturing the table skirt shown in FIG. 1. At step 410, a fabric material is selected and treated for making the table skirt. For example, the fabric material can be selected according to certain standards according to material resilience, reusability, fire resistance, and wrinkle resistance. The fabric material can also be treated with mono-basic acid chlorides to improve wrinkle resistance and treated with a mineral-based barrier to enhance fire resistance. In one embodiment, the fabric material includes polyester. The fabric material may either be woven at full loom or be woven in varying widths of up to 128″, but based upon loom sizes, and length (e.g., 200-450 yards) based upon bolt sizes.

At step 420, the fabric material is cut into a predetermined width, such as about 30″ to 40″. The cut may include sonically slitting that melts the fabric at the cutting edge such that not further hemming procedure is required. The width is between a top side and a bottom side opposite and parallel to the top side. In some embodiments, cutting the fabric material includes sonically slitting. For example, when the predetermined width is about 30″, the original 128″ wide fabric material may be sonically slit into 4 pieces, each having a 30″ width with a loss of 8″. In other examples, the complete 128″ may be utilized fully when each width is of a different predetermined value. In another example, a smaller width of fabric material is loomed for a width of approximately 121″-124″ to avoid excessive cutoff.

At step 430, a horizontal attachment strip is aligned adjacent and parallel to the top side of the fabric material. The attachment stripped is aligned adjacent the top side. The attachment strip includes a carrier that can be secured to the fabric material and can receive a film of bonding adhesives. For example, a film of adhesives is applied onto the carrier; and a protective film further covers the film of adhesives for protection until deployment. In some implementations, the carrier includes high-density polyethylene fibers. The film of adhesives includes one of water-based synthetic lattices, ethylene/vinyl acetate, acrylic pressure-sensitive tape, solvent-based single-component polyurethane, synthetic rubber, and hot glue. The protective film can include silicone or polytetrafluoroethylene.

At step 440, the top side is pleated (e.g., overlapping part of itself, or folded onto part of itself) with a thread stitching through the attachment strip and the fabric material to create a curve shape of the bottom side. For example, at an even interval, part of the top side is overlapped onto itself to result in a length matching the length of the bottom side. The fabric material now presents a rectangular shape. In some implementations, the top side has been designed to be curved so as to form a straight line after the overlapping procedure. The thread holds the fabric material into the rectangular shape formed from overlapping or folding part of the top side of the cut fabric material. In some implementations, a vertical attachment strip similar to the horizontal strip is also stitched to the fabric material adjacent the laterals of the rectangular shape. The stitched attachment strips can hold the table skirt securely to the show table and can allow for quick removal after use.

In some embodiments, the attachment strip is glued onto the pleated top side of the fabric material. For example, instead of stitching, a layer of adhesives is applied between the attachment strip and top side of the fabric material. The layer of adhesives can cure to permanently hold the attachment strip to the pleated top side. The layer of adhesives can provide reasonable bonding capacity to hold the attachment strip during handling, installation, removal, and secure the table skirt on the table. In other embodiments, both adhesives and threads may be used to secure the attachment strip onto the pleated top side.

At step 450, the pleated fabric material is hot knifed into pieces having a predetermined length. The hot knife cutting also separates the attachment strip of each fabric piece. In some embodiments, the predetermined length is about 4.27 m or 14′. Other predetermined length values are possible, such as 4.12 m or 13′6″.

In the foregoing description of certain embodiments, specific terminology has been chosen for the sake of clarity. However, the disclosure is not intended to be limited to the specific terms selected, and it is to be understood that each specific term includes other technical equivalents which operate in a similar manner to accomplish a similar technical purpose.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear. In addition, the foregoing describes some embodiments of the disclosure, and alterations, modifications, additions and/or changes can be made thereto without departing from the scope and spirit of the disclosed embodiments, the embodiments being illustrative and not restrictive.

Furthermore, the disclosure is not to be limited to the illustrated implementations, but to the contrary, is intended to cover various modifications and equivalent arrangements included within the spirit and scope of the disclosure. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A table skirt comprising:
a fabric material having a top side and a bottom side opposite and parallel to the top side; and
an attachment strip pleating the fabric material by overlapping part of the top side onto itself to create a curve shape of the bottom side, the attachment strip comprising:
a protective layer;
a film of adhesives; and
a carrier secured to the pleated top side of the fabric material by a thread or a layer of adhesives.

2. The table skirt of claim 1, wherein the fabric material further comprises a mesh of durable fibers that are resistant to a cleansing detergent.

3. The table skirt of claim 1, wherein the fabric material is fire resistant and abides by at least one of CA 117, BS 5815-1 2005, BS 5852:2006, BS 7175, CRIB 5, IMO A563, and NFPA 701 standards.

4. The table skirt of claim 3, wherein the fabric material further comprises polyester.

5. The table skirt of claim 1, wherein the fabric material is cross-linked.

6. The table skirt of claim 5, wherein the fabric material comprises cellulose molecules having strengthened hydrogen bonds.

7. The table skirt of claim 1, wherein the protective layer includes silicone or polytetrafluoroethylene.

8. The table skirt of claim 1, wherein the film of adhesives and the layer of adhesives comprise one of water-based synthetic lattices, ethylene/vinyl acetate, acrylic pressure-sensitive tape, solvent-based single-component polyurethane, synthetic rubber and hot glue.

9. The table skirt of claim 1, wherein the carrier further comprises high-density polyethylene fibers.

10. The table skirt of claim 1, wherein the thread has a weight of about 4 to 8 ounce.

11. The table skirt of claim 10, wherein the thread further comprises polyester or para-aramid synthetic fibers.

12. The table skirt of claim 1, wherein the thread is stitched at the width of the protective layer to hold the attachment strip onto the fabric material.

13. A method for manufacturing a table skirt, the method comprising:
cutting a fabric material having a top side and a bottom side opposite and parallel to the top side;
aligning an attachment strip adjacent the top side, wherein the attachment strip includes a carrier;
pleating the top side of the fabric material; and
securing the pleated top side with the carrier.

14. The method of claim 13, wherein securing the pleated top side with the carrier further comprises stitching a thread through the fabric material and the carrier or applying a layer of adhesives between the carrier and the pleated top side.

15. The method of claim 13, further comprising treating the fiber material with a mineral based barrier.

16. The method of claim 13, further comprising treating the fabric material with mono-basic acid chlorides.

17. The method of claim 13, further comprising applying a film of adhesives onto the carrier, wherein the film of adhesives has a different composition than the layer of adhesives between the carrier and the fabric material.

18. The method of claim 17, further comprising applying a protective layer onto the film of adhesives on the carrier.

19. The method of claim 13, wherein the carrier comprises high-density polyethylene fibers.

20. A method for making a self-adhering cloth, the method comprising:
cutting a fire-resistant, and wrinkle resistant fabric material having a top side and a bottom side opposite and parallel to the top side;
pleating the top side to create a curve shape of the bottom side;
aligning an attachment strip adjacent the top side, wherein the attachment strip includes a carrier, a film of adhesives on the carrier, and a protective layer sandwiching the film of adhesives with the carrier; and
stitching a thread through the fabric material and the carrier to secure the attachment strip to maintain the pleated top side.

21. A method for making a self-adhering cloth, the method comprising:
cutting a fire-resistant, and wrinkle resistant fabric material having a top side and a bottom side opposite and parallel to the top side;
pleating the top side to create a curve shape of the bottom side;
aligning an attachment strip adjacent the top side, wherein the attachment strip includes a carrier, a film of adhesives on the carrier, and a protective layer sandwiching the film of adhesives with the carrier; and
gluing the carrier to the pleated top side of the fabric material to secure the attachment strip to maintain the pleated top side.
